(19) United States
(12) Patent Application Publication
(10) Pub. No.: US 2015/0067290 A1
(43) Pub. Date: Mar. 5, 2015

(54) MEMORY ACCESS TIME TRACKING IN DUAL-RAIL SYSTEMS

(71) Applicant: QUALCOMM Incorporated, San Diego, CA (US)

(72) Inventors: Ritu CHABA, Bangalore (IN); Balachander GANESAN, Mountain View, OR (US); ChangHo JUNG, San Diego, CA (US); Sei Seung YOON, San Diego, CA (US)

(73) Assignee: QUALCOMM Incorporated, San Diego, CA (US)

(21) Appl. No.: 14/018,399

(22) Filed: Sep. 4, 2013

(51) Int. Cl. G06F 13/16

(52) U.S. Cl. CPC G06F 13/1689; G06F 2212/1028
USPC 711/167

(57) ABSTRACT

Disclosed are various apparatuses and methods for memory access time tracking in dual-rail systems. An apparatus may include a memory coupled to a first voltage rail and having a data output, a data circuit coupled to a second voltage rail and configured to receive the data output from the memory, and a timing circuit configured to adjust an access time of the memory based on a second voltage rail level. A method may include determining a voltage rail level of a data circuit, adjusting the access time of the memory based on the voltage rail level of the data circuit, outputting data from the memory, and receiving the output data by the data circuit.

### BACKGROUND

1. Field

The present disclosure relates generally to integrated circuits, and more particularly, to memory access time tracking in dual-rail systems.

2. Background

A system on a chip (SoC) is an integrated circuit that integrates the components of a complete system on a chip. It contains a large number of “hard” intellectual property blocks known as “hard macros” (HM). A HM may be a functional unit (e.g., processor, graphics, modem, etc.), memory, or the like. Typically, memory is not implemented as a single HM, but rather as a large number of smaller HMs.

The functional units and the memory are powered from different voltage rails. The memory voltage rail is shared between all memory HMs. The performance mode of these memory HMs may be different at any given time. Some may be in low power mode and others may be in high power mode. There is a dedicated voltage rail for each functional unit HM. The voltage rail for each functional unit HM is set to a level based on its power mode. This creates a scenario where an HM for a functional unit in the low power mode can have logic gates powered at a lower voltage level while memory is powered at a higher voltage level to support the high power mode of other memory HMs. Under this scenario, timing the latching of data from the memory may be challenging. Accordingly, there is a need in the art for controlling the timing in dual-rail systems to ensure proper operation of the circuits.

### SUMMARY

One aspect of an apparatus is disclosed. The apparatus includes a memory coupled to a first voltage rail and having a data output, a data circuit coupled to a second voltage rail and configured to receive the data output from the memory, and a timing circuit configured to adjust an access time of the memory based on a second voltage rail level.

One aspect of a method of adjusting an access time of the memory is disclosed. The method includes determining a voltage rail level of a data circuit, adjusting the access time of the memory based on the voltage rail level of the data circuit, outputting data from the memory, and receiving the output data by the data circuit.

Another aspect of an apparatus is disclosed. The apparatus comprising a memory coupled to a first voltage rail and comprising a means for outputting data, a data circuit coupled to a second voltage rail and comprising a means for receiving the output data from the memory, and a timing circuit comprising a means for adjusting an access time of the memory based on a second voltage rail level.

Other aspects of apparatuses and methods described herein will become readily apparent to those skilled in the art based on the following detailed description, wherein various aspects of apparatuses and methods are shown and described by way of illustration. These aspects may be implemented in many different forms and its details may be modified in various ways without deviating from the scope of the present invention. Accordingly, the drawings and detailed description provided herein are to be regarded as illustrative in nature and not as restricting the scope of the claims.

### BRIEF DESCRIPTION OF THE DRAWINGS

Various aspects of apparatuses and methods will now be presented in the detailed description by way of example, and not by way of limitation, with reference to the accompanying drawings, wherein:

FIG. 1 is an architectural illustration of an example dual-rail system.

FIG. 2 is a block diagram illustrating one example of the memory.

FIG. 3 is a schematic representation of various components of the memory.

FIG. 4 is a schematic representation of another example of the delay in the timing circuit of the memory.

FIGS. 5A and 5B illustrate exemplary timing of the timing circuit of the memory.

FIG. 6 is a flowchart illustrating one example of an operation performed by the timing circuit of the memory.

### DETAILED DESCRIPTION

Various aspects of the disclosure will be described more fully hereinafter with reference to the accompanying drawings. This disclosure may, however, be embodied in many different forms by those skilled in the art and should not be construed as limited to any specific structure or function presented herein. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of this disclosure, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure and/or functionality in addition to or instead of other aspects of this disclosure. It should be understood that any aspect of the disclosure disclosed herein may be embodied by one or more elements of a claim.

Although particular aspects will be described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different circuits, technologies, systems, networks, and methods, some of which are illustrated by way of example in the drawings and in the following description. The detailed description and drawings are merely illustrative of the disclosure rather than limiting, the scope of the disclosure being defined by the appended claims and equivalents thereof.

The various circuits described throughout this disclosure may be implemented in various forms of hardware. By way of example, any of these circuits, either alone or in combination, may be implemented as an integrated circuit, or as part of an integrated circuit. The integrated circuit may be an end product, such as a microprocessor, a digital signal processor (DSP), an application specific integrated circuit (ASIC), programmable logic, memory, or any other suitable integrated circuit. Alternatively, the integrated circuit may be integrated with other chips, discrete circuit elements, and/or other components as part of either an intermediate product, such as a motherboard, or an end product. The end product can be any suitable product that includes integrated circuits, including by way of example, a cellular phone, a personal digital assistant (PDA), a laptop computer, a desktop computer (PC), a computer peripheral device, a multimedia device, a video device, an audio device, a global positioning system (GPS), a wireless sensor, or any other suitable device.

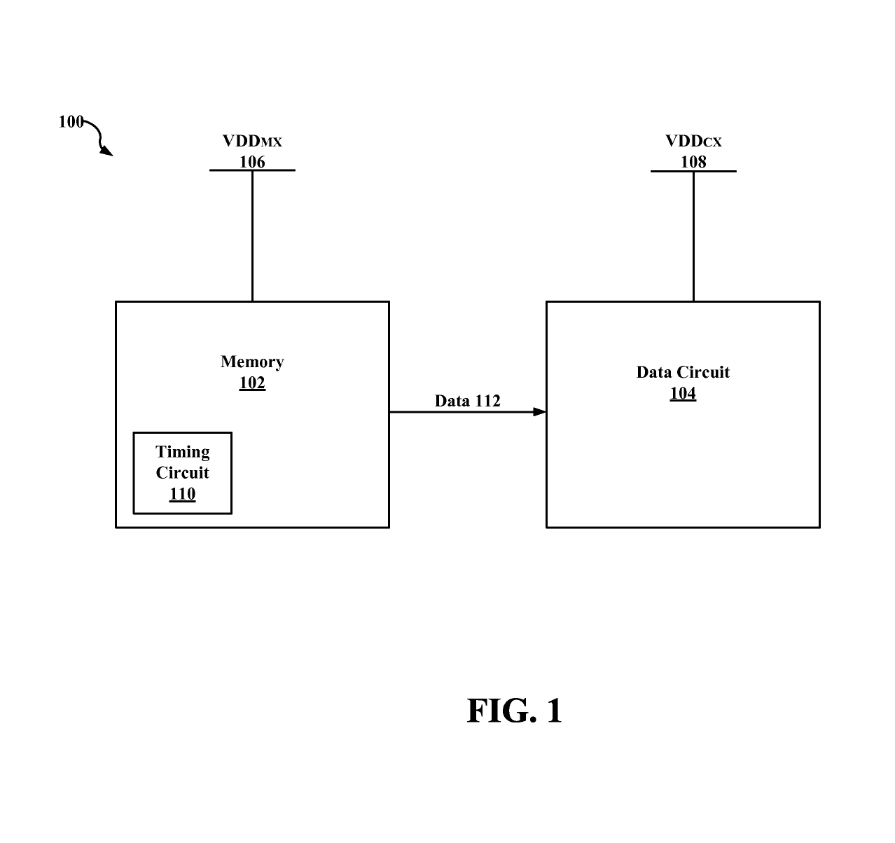

FIG. 1 is an architectural illustration of an example dual-rail system 100. The dual-rail system 100 is shown with a memory 102 coupled to a first voltage rail VDD_{MX} 106 and a data circuit 104 coupled to a second voltage rail VDD_{CX} 108. In this example, the memory 102 provides a means for outputting data and the data circuit 104 provides a means for receiving data output from the memory 102. More specifically, the memory 102 provides a medium for a processor (not shown) or other device to store and retrieve program instructions and data. As used hereinafter, the term “data” will be understood to include program instructions, data, and any other information that may be stored in the memory 102. The data may be stored or retrieved by the processor over a bus. When writing to the memory 102, the processor sends an address to the memory 102 with a write enable signal and the data to be written to the memory 102. When reading from the memory 102, the processor sends the address to the memory 102 with a read enable signal. In response, the memory 102 sends data to the processor over the bus. In this example, the data circuit 104 represents any functional unit capable of receiving data read from the memory 102, including by way of example, the processor, a circuit between the memory 102 and the processor, or any other suitable circuit capable of receiving data.

Various timing requirements may apply to the system 100. A common timing requirement is the “access time” of the memory 102. The access time indicates the time required to read or write to the memory 102. In the case of a read operation, it is typically measured from the clock edge to the time the data output from the memory 102 becomes valid. Other common timing requirements include the “setup time” and the “hold time.” In connection with the data circuit 104, the setup time is the time the data at the input to the data circuit 104 must be valid before the clock edge and the hold time is the time that the data at the input to the data circuit 104 must remain valid after the clock edge.

In at least one embodiment of a system 100, the memory 102 includes a timing circuit 110. The timing circuit 110 may provide various functions, including by way of example, adjusting certain parameters to ensure that the timing requirements are met. By way of example, the timing circuit 110 may provide a means for adjusting the access time of the memory 102 when the memory 102 is operating in a high power mode and the data circuit 104 is operating in a low power mode. Under these conditions, the access time for the memory may be too fast to meet the hold time for the data circuit. In other words, the data provided to the data circuit 104 by the memory 102 may change too quickly after the clock edge to meet the hold time requirements of the data circuit 104. In this example, the timing circuit 110 may be used to reduce the access time of the memory 102.

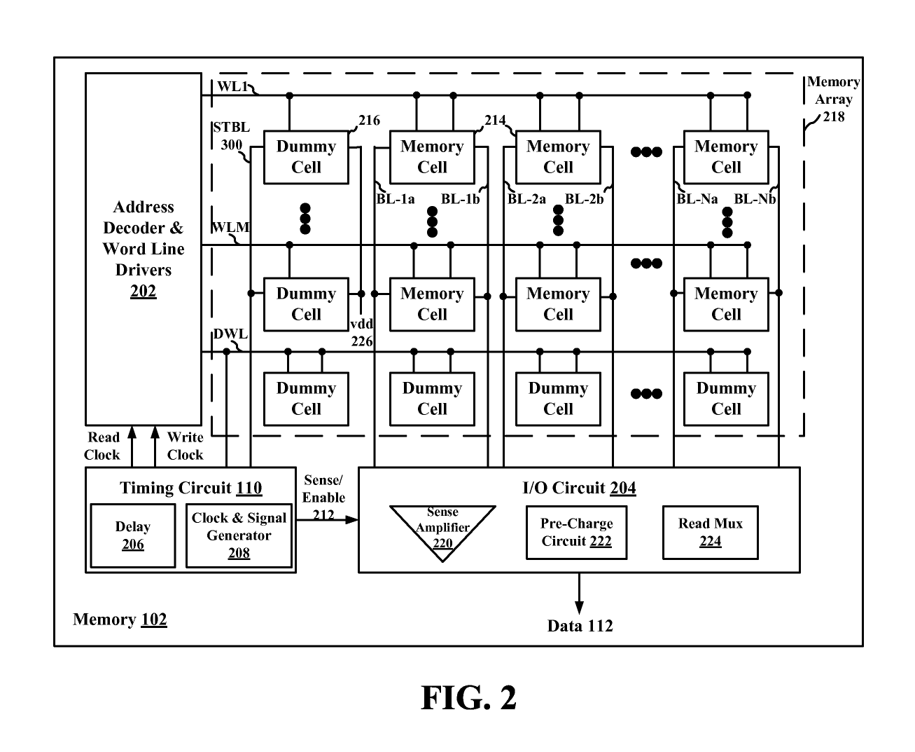

FIG. 2 is a block diagram illustrating one example of the memory 102 suitable for use with a data circuit in a dual-rail system. In this example, the memory 102 is a static random access memory (SRAM), however, as those skilled in the art will appreciate, other memories may be used and the various aspects presented throughout this disclosure are equally applicable to such memories and other suitable devices. Examples of other memories include random access memory (RAM), dynamic RAM (DRAM), synchronous dynamic RAM (SDRAM); double date rate RAM (DDRAM), read only memory (ROM), programmable ROM (PROM), erasable PROM (EPROM), electrically erasable PROM (EEPROM), a general register on a processor, flash memory, or any other suitable memory.

In the example illustrated in FIG. 2, the memory 102 includes an address decoder and word line drivers 202, a memory array 218, the timing circuit 110, and an I/O circuit 204. As explained earlier, a processor may provide the address and control signals over a bus to read and write from the memory 102. In the described embodiment, the control signals (i.e., read and write enables) may be provided to the timing circuit 110. The timing circuit 110 uses the control signals to generate a read clock for a read operation and/or a write clock for a write operation. The clock is provided to the address decoder and word line drivers 202 along with the address transmitted by the processor over the bus to access the appropriate memory cell or cells 214 in the memory array 218. However, as those skilled in the art will readily understand, the address and control signals may be provided by other devices either external or internal to the memory 102.

The memory array 218 may include M number of rows and N number of columns of memory cells 214. In general, M and N may each have any positive integer value. The M rows of memory cells 214 are selected via M word lines, which are depicted as word lines WL1 through WLM. The N columns of memory cells 214 are coupled to N number of differential bit lines BL-1a and BL-1b through BL-Na and BL-Nb. The address decoder & word line drivers 202 may be used to decode the address transmitted by the processor on the bus to activate the appropriate word and differential bit lines to access the desired memory cells 214.

In addition to memory cells 214, the memory array 218 may include one row and one column of dummy cells 216. The dummy cells 216 are used to track the access time of certain memory cells 214 during read and/or write operations. By way of example, during a read operation, the differential bit lines attached to the selected column of memory cells 214 are pre-charged by the pre-charge circuit 222. Afterwards, the word line attached to the selected row of memory cells 214 is asserted, causing one of the two differential bit lines to discharge. The discharge time depends on the capacitive loading of that particular bit line, which is a function of the number of memory cells (e.g., M) attached to that particular bit line.

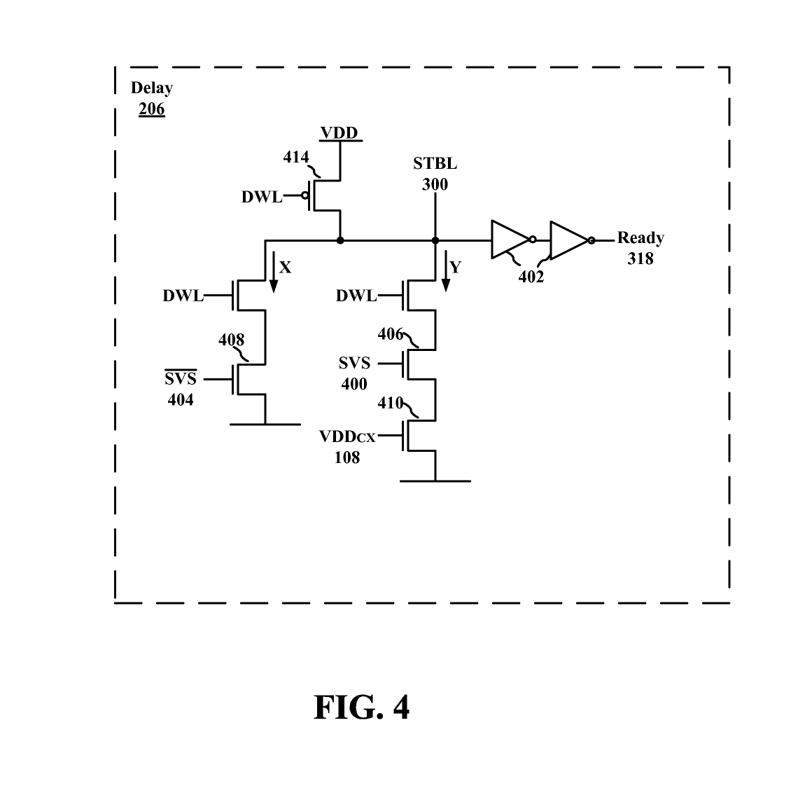

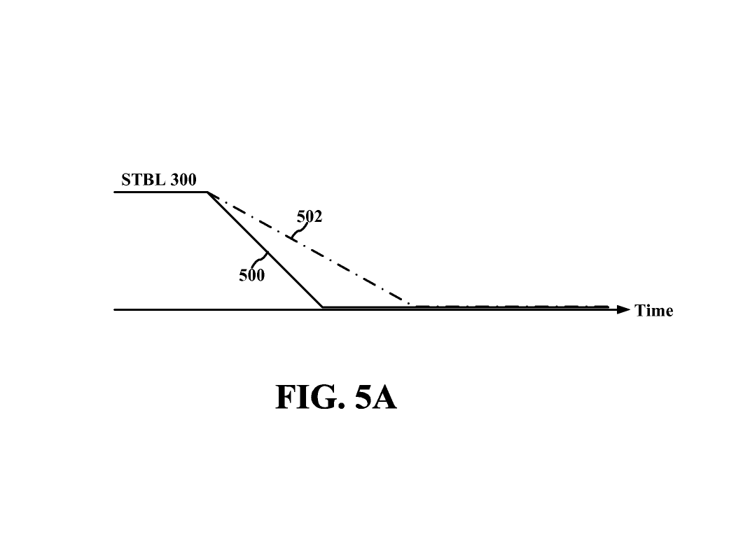

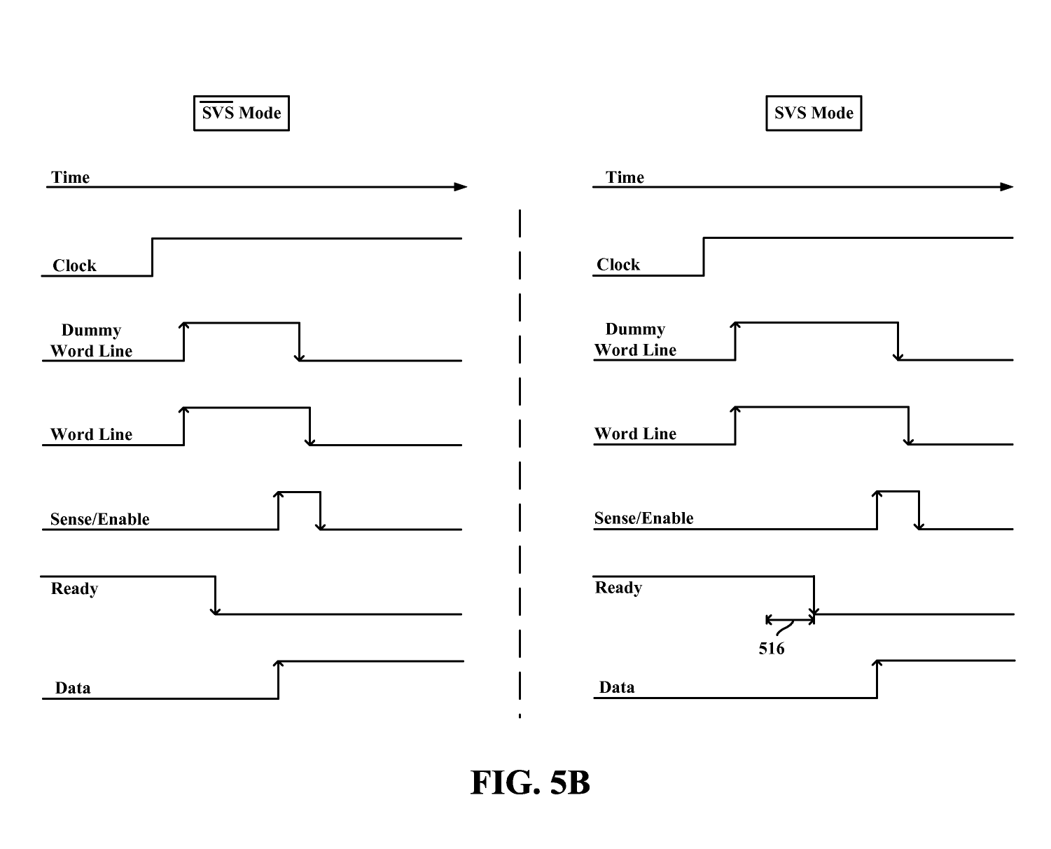

The dummy cells 218 are used to emulate the capacitive loading on that particular bit line. This is achieved by loading a dummy bit line, referred to as the self-timed bit line (STBL 300), with M number of dummy cells 216. As discussed in greater detail below with respect to FIGS. 4 and 5, STBL 300 is initially pulled up to V_{DD} when the memory is idle. A dummy word line DWL is used to initiate the discharge of the STBL 300. The DWL is loaded with a row on N dummy cells 216 to emulate the loading on the selected word line. The discharge time of STBL 300 will track the discharge time of the differential bit lines of the selected column of memory cells 214.

Once the STBL 300 is discharged, the timing circuit 110 provides a sense/enable signal 212 to the sense amplifier 220 in an I/O circuit 204. The sense amplifier 220 senses the voltage difference between the differential bit lines for the selected memory cell 214 when the sense/enable signal 212 is asserted. The appropriate differential bit lines may be provided to the sense amplifier 220 by a read multiplexer 224 in the I/O circuit 204. In a manner to be described in greater detail later, a delay 206 in the timing circuit 110 may be used to adjust the timing of the sense/enable signal 212.

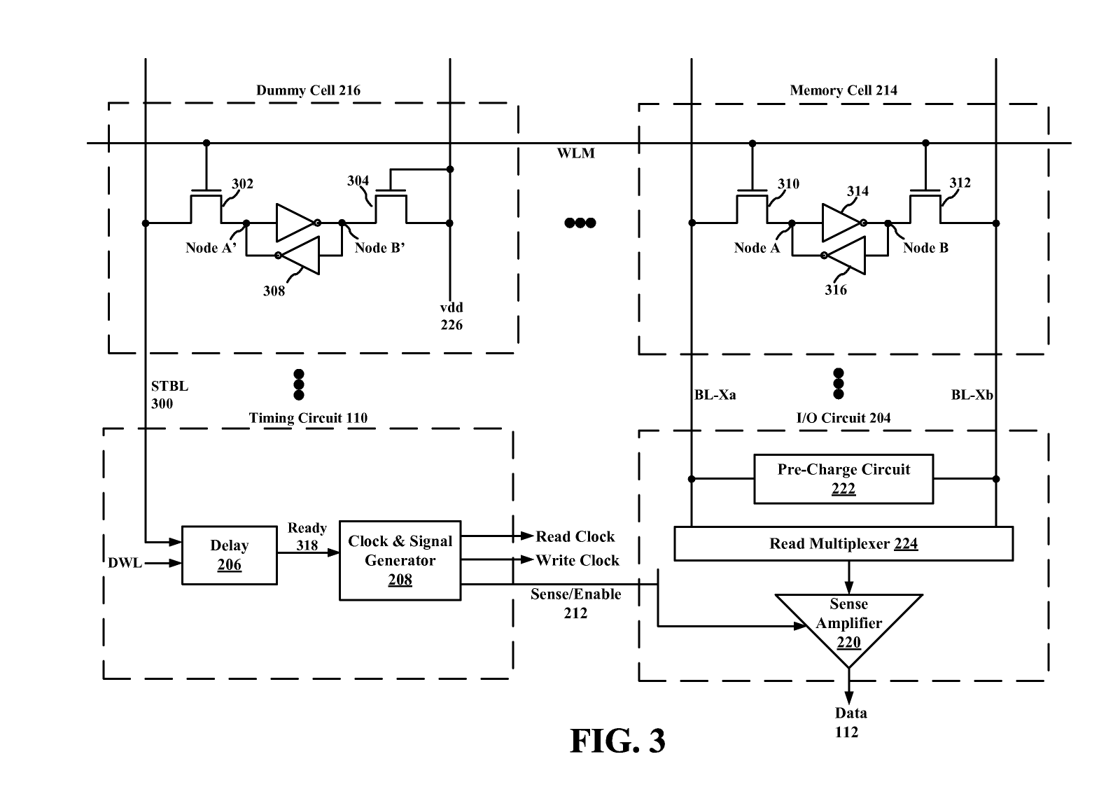

FIG. 3 is a schematic representation of various components of the memory 102. For simplicity, FIG. 3 illustrates one memory cell 214 and one dummy cell 216, in addition to the timing circuit 110 and the I/O circuit 204.

The memory cell 214 includes a pair of cross-coupled inverters 314, 316 and a pair of n-channel transistors 310, 312. Inverter 314 has its input coupled to node A and its output coupled to node B. Inverter 316 has its input coupled to node B and its output coupled to node A. The n-channel transistor 310 has its drain coupled to node A, its source coupled to bit line BL-Xa, and its gate coupled to word line WLM. The re-channel transistor 312 has its drain coupled to node B, its source coupled to complimentary bit line BL-Xb, and its gate also coupled to word line WLM.

The memory cell 214 stores data according to the data values stored at nodes A and B. If the memory cell 214 stores a logic high (i.e., a ‘1’), then node A is at a logic high and node B is at a logic low (i.e., a ‘0’). If the memory cell 214 stores a logic low, then node A is at a logic low and node B is at logic high. During a read operation, differential bit lines BL-Xa and BL-Xb are pre-charged by the pre-charge circuit 222. The word line WLM is then asserted, thereby turning on n-channel transistors 310, 312.

If memory cell 214 stores a logic high, then bit line BL-Xa remains charged via n-channel transistor 310, and complimentary bit line BL-Xb is discharged via n-channel transistor 312. If memory cell 214 stores a logic low, then bit line BL-Xa is discharged via n-channel transistor 310, and complimentary bit line BL-Xb remains charged via re-channel transistor 312.

The signals carried by the differential bit lines BL-Xa, BL-Xb may be selected by the read multiplexer 224 and provided to the sense amplifier 220. When enabled, the sense amplifier 220 outputs data 112 based on the voltage differential between the differential bit lines BL-Xa, BL-Xb. The sense amplifier 220 is enabled by the sense/enable signal 212 that is output from the timing circuit 110.

The dummy cell 216 is constructed to emulate the memory cell 214. However, the source and gate of pass-through n-channel transistor 304 are coupled to vdd 226 such that node B′ is always pulled high. Since node B′ is always high, node A′ is always low because of inverter 308. When the word line WLM is asserted, n-channel transistor 302 is turned on and the STBL 300 goes low.

The dummy cells 216 are used to load the STBL 300 so that the discharge time tracks the discharge time of the appropriate bit line for the selected differential pair BL-Xa, BL-Xb. When the STBL 300 discharges, the timing circuit 110 generates a sense/enable signal 212 to enable the sense amplifier 220. A delay 206 in the timing circuit 110 may be used to delay the sense/enable signal 212 to ensure that the timing requirements of the memory and the data circuit (not shown) receiving the data 112 from the I/O circuit 204 are met. The delay 206 generates a ready signal 318 that is used by the clock & signal generator 208 to generate the sense/enable 212.

FIG. 4 illustrates a schematic representation of an example of the delay 206. In this example, the dummy word line is low when the memory is in the idle or standby mode. As a result, the STBL 300 is pulled up to VDD through the p-channel transistor 414. When the dummy word line DWL is asserted (e.g., when the dummy word line DWL goes high), during a read operation for example, the STBL 300 discharges through the appropriate dummy memory cell (see FIG. 3) and either path X or path Y.

The low power mode of the data circuit is indicated as SVS (static voltage scaling) 400 and its compliment (i.e., a high power mode) is indicated as S̅V̅S̅ 404. When the dummy word line DWL is asserted and the S̅V̅S̅ 404 signal is high, n-channel transistor 408 is turned on, and STBL 300 will discharge via path X. When the dummy word line DWL is asserted and the SVS 400 signal is high, n-channel transistor 406 will be turned on, and STBL 300 will discharge via path Y.

The n-channel transistor 406 may provide a means for connecting a signal to a pull-down transistor (e.g., n-channel transistor 410) when the data circuit is in a low power mode (e.g., SVS mode). The n-channel transistor 406 may also provide a means for disconnecting the signal from the pull-down transistor (e.g., n-channel transistor 410) when the data circuit is not in a low power mode (e.g., S̅V̅S̅ mode).

The gate of the n-channel transistor 410 is coupled to the voltage of the data circuit (i.e., VDD_{CX} 108). Since the n-channel transistor 410 has a voltage-dependent gate, the degree to which the n-channel transistor 410 is turned on will depend upon the voltage of VDD_{CX} 108. In other words, the resistance of the pull-down circuit corresponding to path Y is a function of VDD_{CX} 108 when n-channel transistors 406, 410 are on. The resistance will affect the discharge rate of STBL 300. As such, the re-channel resistor 410 is acting like a variable resistor, which has a resistance that is based on the voltage of VDD_{CX} 108. The lower the voltage of VDD_{CX} 108, the higher the resistance. The higher the resistance, the longer the discharge time. The longer the discharge time, the slower the discharge rate. By slowing the discharge rate, the rate of the falling edge of STBL 300 may be correspondingly reduced.

FIG. 5A illustrates an example of the reduced rate of the falling edge of the STBL 300, which was previously discussed with respect to path Y in FIG. 4. In FIG. 5A, the adjusted falling edge 502 of STBL 300 is decreasing at a slower rate than the unadjusted falling edge 500 of STBL 300. Accordingly, the adjusted falling edge 502 reaches a bottom value after the unadjusted falling edge 500 reaches a bottom value. Those skilled in the art will understand that different circuits may require different rates of the falling edge of the STBL 300 and, thus, can accordingly adjust the voltage of VDD_{CX} 108 (see FIG. 4).

The rate of the falling edge of the STBL 300 will impact the time that the ready signal 318 is output by the delay 206 (see FIG. 3). The time that the ready signal 318 is output by the delay 206, in turn, impacts the time that the sense/enable signal 212 is generated by the clock & signal generator 208 for purposes of driving the sense amplifier 220 to latch the data 112 (see FIG. 3).

Returning to FIG. 4, the STBL 300 is provided to series inverters 402 whose output is the ready signal 318. The inverters 402 may be used to provide the drive for the ready signal 318. In this example, two inverters 402 are used so that the ready signal 318 may have the same polarity as the STBL 300. However, as those skilled in the art will readily appreciate, any number of inverters may be used depending on the drive, delay and polarity requirements of the memory.

FIG. 5B illustrates exemplary timing when the data circuit is in the high power (i.e., S̅V̅S̅) mode and the low power (i.e., SVS) mode. In both modes, the rising edge of the clock occurs at the same time. Also in both modes, the word line and the dummy word line are asserted simultaneously with the rising edge of the clock. As previously discussed with respect to FIG. 3, the STBL 300 drives the delay 206 when the dummy word line DWL is asserted. The delay 206 (see FIG. 3) generates a ready signal, which is an inverted pulse, as shown in FIG. 5B. When the ready signal goes low, the clock & signal generator 208 (see FIG. 3) generates the sense/enable signal, as also shown in FIG. 5B. The sense/enable signal is used to enable the sense amplifier 220 (see FIG. 3). Once the sense amplifier 220 (see FIG. 3) is enabled, the data from the selected memory cells is output from the memory. The timing of the sense/enable signal dictates the time that the data read from memory is output. For this reason, the sense/enable signal should be generated at a time when the appropriate differential bit-line has fully discharged. If the sense/enable signal is generated at a time that is too early, the output cannot be guaranteed.

The left-hand side of FIG. 5B illustrates exemplary timing when the data circuit is in the high power (i.e., S̅V̅S̅) mode. The right-hand side of FIG. 5B illustrates exemplary timing when the data circuit is in the low power (i.e., SVS) mode. In the right-hand side of FIG. 5B, the ready signal is shown as delayed by an amount of time 516 (relative to the left-hand side of FIG. 5B) due to the effects of the delay 206 of the timing circuit 110 (see FIG. 3). Therefore, adjusting the output timing of the ready signal according to the voltage of the data circuit (e.g., VDD), as previously discussed with reference to FIG. 4, can impact the time that the sense/enable signal is generated, which, in turn, can impact the time that the data is output by the sense amplifier. Once the data is output from the sense amplifier, the word line, and the dummy word line are de-asserted.

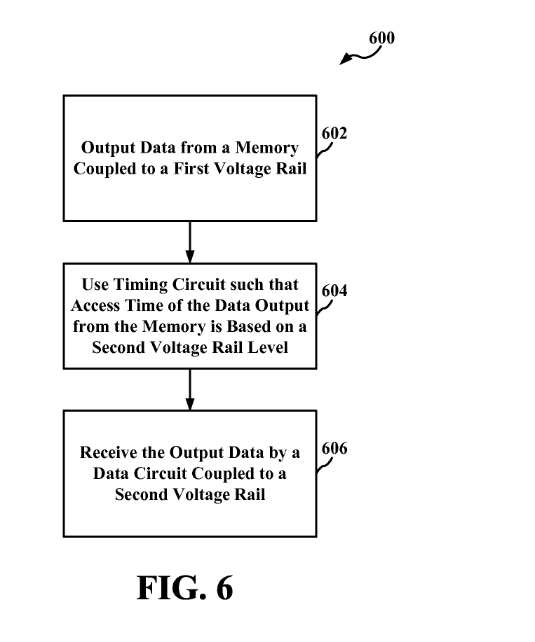

Turning to FIG. 6, a flowchart is illustrated to show one example of an operation performed by the timing circuit of the memory. The operation may include a method 600 that, at block 602, outputs data from a memory that is coupled to a first voltage rail. At block 604, the operation may use a timing circuit such that an access time of the data output from the memory is based on a second voltage rail level. At block 606, the data output from the memory may be received by a data circuit that is coupled to a second voltage rail.

The specific order or hierarchy of blocks in the processes disclosed in FIG. 6 is merely an illustration of one example. Based upon design preferences, the specific order or hierarchy of blocks in the process may be re-arranged, amended, and/or modified. The accompanying method claims include various limitations related to a process, but the recited limitations are not meant to be limited in any way by the specific order or hierarchy depicted in FIG. 6, unless expressly so stated in the claims.

Although various aspects of the present invention have been described as software implementations, those skilled in the art will readily appreciate that the various software modules presented throughout this disclosure may be implemented in hardware, or any combination of software and hardware. Whether these aspects are implemented in hardware or software depends upon the particular application and design constraints imposed on the overall system. Those with ordinary skill in the art may implement the described functionality in varying ways for each particular application, but such implementation decisions should not be interpreted as causing a departure from the scope of the invention. The foregoing description is provided to enable any person skilled in the art to fully understand the scope of the invention. Modifications to various aspects disclosed herein will be readily apparent to those skilled in the art. Accordingly, the scope of the claims will not be limited to the various exemplary embodiments provided herein. Reference to an element in the singular is not intended to mean “one and only one” unless specifically stated as such; instead, reference to an element in the singular shall mean “one or more.” Unless specifically stated otherwise, the term “some” refers to one or more. No claim element is to be construed under the provisions of 35 U.S.C. §112(f) unless the element is expressly recited using the phrase “means for” or, in the case of a method claim, the element is recited using the phrase “step for.” The claims are not intended to be limited to the various aspects of this disclosure, but are to be accorded the full scope consistent with the language of the claims. All structural and functional equivalents to the various components of the exemplary embodiments described throughout this disclosure that are known to those of ordinary skill in the art are expressly incorporated herein by reference and are intended to be encompassed by the claims.

What is claimed is:

1. An apparatus comprising:
a memory coupled to a first voltage rail, the memory having a data output;
a data circuit coupled to a second voltage rail, the data circuit being configured to receive the data output from the memory; and
a timing circuit configured to adjust an access time of the memory based on a second voltage rail level.

2. The apparatus of claim 1, wherein the timing circuit is further configured to increase the access time of the memory in response to a reduction in the second voltage rail level.

3. The apparatus of claim 1, wherein the timing circuit is further configured to provide a signal to the memory, the signal controlling the access time of the memory.

4. The apparatus of claim 3, wherein the timing circuit is further configured to adjust the access time of the memory by controlling the timing of the signal provided to the memory.

5. The apparatus of claim 4, wherein the timing circuit further comprises a pull-down circuit configured to discharge a second signal that triggers the signal provided to the memory.

6. The apparatus of claim 5, wherein the timing circuit is further configured to adjust the access time of the memory by adjusting a discharge slope of the second signal.

7. The apparatus of claim 6, wherein the pull-down circuit comprises a pull-down transistor having a gate controlled by the second voltage rail level.

8. The apparatus of claim 7, wherein the pull-down circuit further comprises a second pull-down transistor configured to:
connect the second signal to the pull-down transistor when the data circuit is in a low power mode; and
disconnect the second signal from the pull-down transistor when the data circuit is not in a low power mode.

9. The apparatus of claim 8, wherein the low power mode is a static voltage scaling (SVS) mode.

10. A method using a timing circuit of a memory coupled to a first voltage rail, the method comprising:
outputting data from the memory; and
receiving the outputted data by a data circuit coupled to a second voltage rail,
wherein an access time of the data output from the memory is based on a second voltage rail level.

11. The method of claim 10, further comprising:
increasing the access time of the memory in response to a reduction in the second voltage rail level.

12. The method of claim 10, further comprising:
providing a signal to the memory using the timing circuit, the signal controlling the access time of the memory.

13. The method of claim 12, further comprising:
adjusting the access time using the timing circuit by controlling the timing of the signal provided to the memory.

14. The method of claim 13, further comprising:
discharging a second signal that triggers the signal provided to the memory using a pull-down circuit of the timing circuit.

15. The method of claim 14, further comprising:
adjusting the access time using the timing circuit by adjusting a discharge slope of the second signal.

16. The method of claim 15, wherein the pull-down circuit comprises a pull-down transistor having a gate controlled by the second voltage rail level.

17. The method of claim 16, wherein the pull-down circuit further comprises a second pull-down transistor, the method further comprising:
connecting the second signal to the pull-down transistor when the data circuit is in a low power mode; and
disconnecting the second signal from the pull-down transistor when the data circuit is not in a low power mode.

18. The method of claim 17, wherein the low power mode is a static voltage scaling (SVS) mode.

19. An apparatus comprising:
outputting means for outputting data, the outputting means being coupled to a first voltage rail;
receiving means for receiving data from the outputting means, the receiving means being coupled to a second voltage rail; and
adjusting means for adjusting an access time of the outputting means based on a second voltage rail level.

20. The apparatus of claim 19, wherein the adjusting means is configured to increase the access time of the outputting means in response to a reduction in the second voltage rail level.

21. The apparatus of claim 19, wherein the adjusting means is configured to provide a signal to the outputting means, the signal controlling the access time of the outputting means.

22. The apparatus of claim 21, wherein the adjusting means is configured to adjust the access time of the outputting means by controlling the timing of the signal provided to the outputting means.

23. The apparatus of claim 22, wherein the adjusting means comprises a pull-down circuit configured to discharge a second signal that triggers the signal provided to the outputting means.

24. The apparatus of claim 23, wherein the adjusting means is further configured to adjust the access time of the outputting means by adjusting a discharge slope of the second signal.

25. The apparatus of claim 24, wherein the pull-down circuit comprises a pull-down transistor having a gate controlled by the second voltage rail level.

26. The apparatus of claim 25, wherein the pull-down circuit further comprises a second pull-down transistor, the apparatus further comprising:
means for connecting the second signal to the pull-down transistor when the data circuit is in a low power mode; and
means for disconnecting the second signal from the pull-down transistor when the data circuit is not in a low power mode.

27. The apparatus of claim 26, wherein the low power mode is a static voltage scaling (SVS) mode.
